(19) United States
(12) Patent Application Publication
(10) Pub. No.: US 2005/0233620 A1
(43) Pub. Date: Oct. 20, 2005

(54) Anisotropic conductive sheet and its manufacturing method

(76) Inventor: Miki Hasegawa, AICHI (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/508,147

(22) PCT Filed: Mar. 20, 2003
(86) PCT No.: PCT/JP03/03460

§ 371 Date: May 19, 2005

(30) Foreign Application Priority Data
Mar. 20, 2002 (JP) 2002-79746

(51) Int. Cl. H01R 4/58

(52) U.S. Cl. 439/91

(57) ABSTRACT

The present invention relates to an anisotropic conductive sheet, which is interposed between a circuit board such as a substrate and various circuit parts to render conductive paths and a manufacturing method thereof, providing the anisotropic conductive sheet securing a fine pitch anisotropic conductivity required by the recent highly integrated circuit boards and electronic parts yet keeping high durability of the conductive member. The anisotropic conductive sheet (10) is constituted by alternately arranging strip-like members (14) of a striped pattern having conductive pieces (24) and nonconductive pieces (22) alternately arranged, and nonconductive strip-like members (12).

### FIELD OF THE INVENTION

The present invention relates to an anisotropic conductive sheet, which is interposed between a circuit board such as a substrate and various circuit devices (components) to render conductive path, and to its manufacturing method.

### RELATED ART

As recent electronic devices become smaller and thinner, there has been more and more increased necessity of connections between circuits of fine patterns and between a minute portion and a circuit of fine patterns. As a connecting method, there are used the solder junction technology and anisotropic conductive adhesives. There is further employed a method of interposing an anisotropic conductive elastomer sheet between electronic components and a circuit board to render a conductive path.

The anisotropic conductive elastomer sheet refers to an elastomer sheet that is conductive only in a specific direction. Generally, there are anisotropic conductive elastomer sheets, which are conductive in only the direction of thickness or would be conductive in only the direction of thickness if pressed in the direction of thickness. Owing to their features of achieving compact electrical connection without any other means such as soldering or mechanical fitting and enabling soft connection so as to absorb mechanical shock and distortion, the anisotropic conductive elastomer sheets have been extensively used in such fields as cell phones, electronic computers, electronic digital timepieces, electronic cameras, computers and the like. They are, further, extensively used as connectors for accomplishing electrical connection between a circuit device such as a printed circuit board and a lead-less chip carrier or a liquid crystal panel.

In the electric inspection of the circuit devices such as printed circuit boards and semiconductor integrated circuits, further, an anisotropic elastomer sheet is heretofore interposed between a region of electrodes of the circuit device to be inspected and a region of inspecting electrodes of the circuit board for inspection in order to achieve electrical connection between the electrodes to be inspected, which are formed on at least one surface of the circuit device to be inspected, and the inspecting electrodes formed on the surface of the inspecting circuit board.

It is known that an example of the above anisotropic conductive elastomer sheet may be obtained by cutting an anisotropic conductive block in a thin sheet such that the block that is formed integrally with thin metal wires disposed in parallel and insulating material enclosing the metal wires is cut in a direction orthogonal to the direction of the thin metal wires (JP-A-2000-340037).

In the anisotropic conductive film with thin metal wires, however, it is difficult to shorten distance between such thin metal wires and to secure anisotropic conductivity with a fine pitch as required by recent highly integrated circuit boards and electronic components. Further, it is likely that thin metal wires are to be buckled with compressive force or the like during the use thereof and easily pulled out after repetitive use so that the anisotropic conductive film may fail to keep its function to a sufficient degree.

In view of the above tasks, it is provided an anisotropic conductive sheet having anisotropic conductivity with fine pitch as required by the recent highly integrated circuit boards and electronic components and being capable of keeping durability in use according to the present invention.

### DISCLOSURE OF THE INVENTION

In the present invention, an anisotropic conductive sheet is characterized in being composed of a striped strip member being arranged with conductive pieces and nonconductive pieces in an alternate manner and a nonconductive strip member, wherein the striped strip member and the nonconductive strip member are alternately arranged.

More specifically, the invention provides the following.

(1) An anisotropic conductive sheet expanding on a plane, wherein when a direction included in said plane is denoted as X-direction, a direction orthogonal to X-direction and contained in said plane is denoted as Y-direction, and a direction orthogonal to both X-direction and Y-direction is denoted as Z-direction, the anisotropic conductive sheet comprising: a predetermined thickness in Z-direction; a front surface and a back surface substantially in parallel with said plane (X-Y plane); strip-like members having a width in Y-direction and extending in X-direction and having a striped pattern with conductive pieces and nonconductive pieces alternately arranged along X-direction, and nonconductive strip-like members having a width in Y-direction and extending in X-direction, wherein the strip-like members and the nonconductive strip-like members are arranged alternately in Y-direction.

(2) The anisotropic conductive sheet according to (1), wherein recurring distance of a conductive piece and a nonconductive piece in the strip-like member of the striped pattern is not longer than approximately 80 μm in X-direction and is not longer than approximately 110 μm in Y-direction, each strip-like member of the striped pattern has a width of not longer than approximately 80 μm, and each nonconductive strip-like member has a width of not longer than approximately 80 μm.

(3) The anisotropic conductive sheet according to (1) or (2), wherein the conductive pieces are composed of conductive elastomer; wherein the nonconductive pieces are composed of first nonconductive elastomer; and wherein the nonconductive strip-like members are composed of second nonconductive elastomer.

(4) The anisotropic conductive sheet according to (3), wherein the conductive pieces, the nonconductive pieces and/or the strip-like members of the striped pattern, and the nonconductive strip-like members are chemically bonded, and wherein such chemical bonding is at least partly accomplished by utilizing a coupling agent.

(5) The anisotropic conductive sheet according to any one from (1) to (4), wherein on the front surface and/or on the back surface of the anisotropic conductive sheet, the conductive pieces are protruding beyond the surrounding nonconductive pieces or the nonconductive strip-like members.

(6) The anisotropic conductive sheet according to any one from (1) to (4), wherein the strip-like members of the striped pattern have a rectangular parallelopiped shape.

(7) The anisotropic conductive sheet according to any one from (1) to (4), wherein the nonconductive strip-like members have a rectangular pallelopiped shape.

(8) A method of manufacturing a flexible anisotropic conductive sheet having a predetermined thickness, and predetermined front surface and back surface on the front and back across the thickness, the method comprising:
a step of alternately laminating a conductive sheet (A) and a first nonconductive sheet (B) to obtain an AB sheet laminate (C);
a first step of cutting the AB sheet laminate (C) obtained in the step of obtaining the AB sheet of a predetermined thickness to obtain a zebra-like sheet;
a step of alternately laminating the zebra-like sheet obtained in the first cutting step and a second nonconductive sheet (D) to obtain a ZD sheet laminate (E); and
a second step of cutting the ZD sheet laminate (E) obtained in the step of obtaining the ZD sheet laminate of a predetermined thickness.

(9) A method of manufacturing the anisotropic conductive sheet, wherein: in the step of obtaining the AB sheet laminate, a coupling agent is applied to the nonconductive sheet (B) prior to laminating the conductive sheet (A) on the nonconductive sheet (B) and the coupling agent is applied to the conductive sheet (A) prior to laminating the nonconductive sheet (B) on the conductive sheet (A), and wherein: in the step of obtaining the ZD sheet laminate, the coupling agent is applied to the nonconductive sheet (D) prior to laminating the zebra-like sheet on the nonconductive sheet (D), and the coupling agent is applied to the zebra-like sheet prior to laminating the nonconductive sheet (D) on the zebra-like sheet.

In the present invention, a flexible anisotropic conductive sheet has a predetermined thickness and predetermined front surface and back surface on the front and back across the thickness. The anisotropic conductive sheet comprises strip-like members having a predetermined height substantially equivalent to the predetermined thickness, a predetermined width and a length longer than the above height and width, the strip-like members having a striped pattern alternately arranging conductive pieces and nonconductive pieces in a longitudinal direction of the strip-like members; and nonconductive strip-like members having a predetermined height substantially equivalent to the predetermined thickness, a predetermined width and length longer than the above height and width. The strip-like members and the nonconductive strip-like members are arranged in the width direction by lining them up to the heights and lengths thereof, so that the heights substantially correspond to the thickness of the anisotropic conductive sheet.

The description that “when a direction contained in a plane is denoted as X-direction, a direction orthogonal to X-direction and contained in said plane is denoted as Y-direction, and a direction orthogonal to X-direction and Y-direction is denoted as Z-direction, the anisotropic conductive sheet has a predetermined thickness in Z-direction and a front surface and a back surface substantially in parallel in said plane (X-Y plane)” may be the same features as an ordinary sheet has. This anisotropic conductive sheet may have a given thickness, and may have a front surface and a back surface characterized by a larger size than the thickness on the back and forth faces or up and down faces across the thickness. The word “flexible” means that the sheet can be bent. The strip-like member of the striped pattern may have a slender shape in which conductive pieces and nonconductive pieces are alternately connected together. The height (or thickness) of the strip-like member of the striped pattern may be substantially the same as the height (or thickness) of the conductive piece and of the nonconductive piece, and may have a predetermined height (or thickness). The width of the strip-like member of the striped pattern may be substantially the same as the width of the conductive piece and of the nonconductive piece and may have a constant width. The nonconductive strip-like member may have a height (or a thickness) and a length nearly the same as those of the strip-like members of the striped pattern. Therefore, the strip-like member having a large width is obtained by coupling strip-like members of the striped pattern and the nonconductive strip-like member in the direction of width maintaining regular height and length, and may have a width greater than, or substantially equal to, the sum of widths of the strip-like members of the striped pattern and widths of the nonconductive strip-like members.

Being conductive means that the electric conductivity may be sufficiently high, or that the electric resistance may be sufficiently low. It may mean that the anisotropic conductive sheet having such a configuration as a whole has the electric conductivity capable of exhibiting a sufficient degree thereof in its conductive direction. Usually, the resistance among the terminals to which the connection is made is preferably not larger than 100 Ω (more preferably not larger than 10 Ω and, yet more preferably not larger than 1 Ω). Being nonconductive means that the electric conductivity may be sufficiently low, or that the electric resistance may be sufficiently high. It may mean that the anisotropic conductive sheet having such a configuration as a whole has the nonconductivity capable of exhibiting a sufficient degree thereof in its non-conductive direction, and the resistance is preferably not smaller than 10 kΩ (more preferably not smaller than 100 kΩ and, yet more preferably not smaller than 1 MΩ).

The alternately arranged strip-like members of the striped pattern may be slender members in which conductive pieces and nonconductive pieces are alternately arranged exhibiting striped patterns if their colors are not the same.

Indeed, they need not appear in a striped pattern. The alternate arrangement needs not spread over the whole strip-like members of the striped pattern but may exist in only a portion thereof.

The recurring distance corresponds to a distance obtained by adding up the lengths of the neighboring conductive piece and nonconductive piece (in a longitudinal direction of the strip-like member) and dividing the sum of the lengths by two. When there are a plurality of such distances, the recurring distance may be the shortest distance among them. Generally, further, when a substantially straight line is drawn on a sheet and traced to go through a conductive piece (I)/nonconductive piece (II)/conductive piece (III)/nonconductive piece (IV) or through a nonconductive piece (I)/conductive piece (II)/nonconductive piece (III)/conductive piece (IV), the recurring distance is thought to be represented by the one obtained by adding up, when passing through (II) and (III) above, their respective distances together and diving the sum thereof by two. The terminal gap between applied terminals may mean distance between the applied terminals in a direction in which the sheet is nonconductive when a circuit board and/or an electric component has a plurality of terminals to be connected in a direction in which the anisotropic conductive sheet is conductive. When there are various distances in the terminal gaps, the terminal gap between the terminals may be the shortest distance.

In the present invention, further, the recurring distance of the conductive piece and the nonconductive piece in the strip-like member of the striped pattern is not longer than approximately 80 μm in X-direction, not longer than approximately 110 μm in Y-direction; the width of the strip-like member of the striped pattern is not longer than approximately 80 μm, and the width of the nonconductive strip-like member is not longer than approximately 80 μm. The striped pattern needs not really appear as stripes but is simply expressing an alternately arranged state. Here, the recurring distance is the same as described above; i.e., the recurring distances in X- and Y-directions are not longer than approximately 80 μm in X-direction, not longer than approximately 110 μm in Y-direction, and the above two widths may not be longer than approximately 80 μm. More preferably, they are not longer than approximately 50 μm, respectively.

In the present invention, further, the conductive piece may comprise conductive elastomer, the nonconductive piece may comprise a first nonconductive elastomer, and the nonconductive strip-like member may comprise a second nonconductive elastomer. The first nonconductive elastomer and the second nonconductive elastomer may be the same or different.

In the present invention, further, the conductive pieces and the nonconductive pieces and/or the strip-like members of the striped pattern and the nonconductive strip-like members may be chemically bonded together, wherein such chemical bonding may be at least partly accomplished by utilizing a coupling agent. In the present invention, the above elements may be chemically bonded, and the anisotropic conductive sheet may be handled as a unitary structure. In the case of an uncured elastomer (which has not been cross-linked such as by heat treatment) in general, the chemical coupling on the molecular level with a similarly uncured elastomer or a cured elastomer is accomplished by curing (i.e., by cross-linking treatment based on heating). Not only for the above combinations but also for any other combinations (of elastomers), the chemical coupling can be accomplished on the interface on a molecular level by using the coupling agent (which may include the surface treatment using a primer or the like). The chemical coupling features a strong binding that is stronger than that between the elastomer and fine metal wires in the anisotropic conductive sheet containing fine metal wires in the elastomer. This chemical coupling can be taken as the term in contrast to the physical coupling or the mechanical coupling.

Conductive elastomer stands for elastomer having electric conductivity and is, usually, elastomer blended with conductive material so as to lower the volume resistivity (smaller than, for example, 1 Ω·cm or less). By way of example, usable elastomer may include butadiene copolymers such as natural rubber, polyisoprene rubber, butadiene/styrene, butadiene/acrylonitrile, butadiene/isobutylene and the like, conjugated diene rubber and hydrogenated derivatives thereof; block copolymer rubbers such as styrene/butadiene/diene block copolymer rubber and styrene/isoprene block copolymer and hydrogenated derivatives thereof; and chloroprene copolymer; vinyl chloride/vinyl acetate copolymer; urethane rubber; polyester rubber; epichlorohydrin rubber; ethylene/propylene copolymer rubber; ethylene/propylene/diene copolymer rubber; soft liquid epoxy rubber; silicone rubber; fluororubber, and so on. Among them, the silicone rubber is preferably used because of its excellent heat resistance, cold resistance, chemical resistance, weathering resistance, electric insulation and safety. Such elastomer may be blended with metal powders, flakes, small pieces, foils and nonmetallic powders such as carbon, or with conductive substance such as flakes, small pieces or foils to construct conductive elastomer. Examples of metal may include gold, silver, copper, nickel, tungsten, platinum, palladium and any other pure metals, and alloys such as stainless steel, phosphor bronze or beryllium copper and so on. Here, carbon may include carbon nano-tube, fullerene, etc.

Nonconductive elastomer stands for elastomer with no conductivity or a very low conductivity. By way of example, usable nonconductive elastomers include natural rubber, butadiene copolymers such as polyisoprene rubber, butadiene/styrene, butadiene/acrylonitrile, and butadiene/isobutylene; conjugated diene rubber and hydrogenated derivatives thereof; block copolymer rubbers such as styrene/butadiene/diene block copolymer rubber, styrene/isoprene block copolymer, and hydrogenated derivatives thereof; chloroprene copolymer; vinyl chloride/vinyl acetate copolymer; urethane rubber; polyester rubber; epichlorohydrin rubber; ethylene/propylene copolymer rubber; ethylene/propylene/diene copolymer rubber; soft liquid epoxy rubber; silicone rubber or fluororubber. Among them, the silicone rubber is preferably used because of its excellent heat resistance, cold resistance, chemical resistance, weathering resistance, electric insulation and safety. Such nonconductive elastomer usually has a high volume resistivity (e.g., not smaller than 1 MΩ·cm at 100 V) and are nonconductive.

The coupling agent for coupling these conductive and nonconductive elastomers is the one for coupling these members, and may include a usual commercial adhesive. Examples thereof include coupling agents of silane, aluminum and titanate types. Among them, silane coupling agent is favorably used.

In the anisotropic conductive sheet according to the present invention, the conductive piece may protrude compared to the nonconductive matrix. “Protruding” refers to a case where the portion of the conductive piece is thicker than the portion of the nonconductive matrix in the thickness of the anisotropic conductive sheet, a case where the position of the upper surface of the nonconductive matrix is lower than that of the upper surface of the conductive piece when the anisotropic conductive sheet is horizontally placed, and/or a case where the position of the lower surface of the nonconductive matrix is higher than that of the lower surface of the conductive piece when the anisotropic conductive sheet is horizontally placed. With such configurations, the electric contact of the electronic parts and that of the terminals of the substrate become more reliable. This is because the terminals, first, come in contact with the conductive pieces as they approach the sheet, and a suitable degree of contact pressure is secured due to the pushing force to the sheet.

Alternatively, in the present invention, said strip-like members of the striped pattern may have a rectangular parallelopiped shape. Further, said nonconductive strip-like members may have a rectangular parallelopiped shape.

The present invention further relates to a method for manufacturing a flexible anisotropic conductive sheet having a predetermined thickness, and predetermined front and back surfaces on the front and back across this thickness, wherein said method comprises: a step of alternately laminating a conductive sheet (A) and a first nonconductive sheet (B) to obtain an AB sheet laminate (C); a first step of cutting the AB sheet laminate (C) in a predetermined thickness to obtain a zebra-like sheet member; a step of alternately laminating the zebra-like sheet member and a second nonconductive sheet (D) to obtain a ZD sheet laminate (E); and a second step of cutting the ZD sheet laminate (E) in a predetermined thickness.

Here, the conductive sheet (A) and the nonconductive sheet (B) may be, respectively, sheet members of a single kind or collections of sheet members of different kinds. For example, the conductive sheet (A) may be a collection of sheet members of the same material but having different thicknesses. Alternately laminating may mean that the conductive sheet (A) and the nonconductive sheet (B) are alternately laminated in any order, but does not exclude interposing a third sheet, film, and other member between the conductive sheet (A) and the nonconductive sheet (B). In the step of laminating the sheet members, further, a coupling agent may be applied between the sheets so that the sheets are coupled together. Such an AB sheet laminate (C) prepared by stacking may be further heated from the standpoint of increasing binding strength between sheets, promoting the curing of the sheet members themselves or for any other purposes.

The AB sheet laminate (C) can be cut using a blade such as a super steel cutter or a ceramic cutter; a grindstone such as a fine cutter; a saw, or any other cutting device or cutting instrument (which may include a cutting device of the non-contact type, such as laser cutter). In the step of cutting, further, a cutting fluid such as a cutting oil may be used to prevent over-heating, and obtain finely cut surfaces or for any other purposes, or a dry cutting may be employed. Further, the object (e.g., work) may be cut alone or by being rotated together with the cutting machine or instrument. Needless to say, a variety of conditions for cutting are suitably selected to meet the AB sheet laminate (C). To cut a sheet in a predetermined thickness means the cutting to obtain a sheet member having a predetermined thickness. The predetermined thickness needs not be uniform but may vary depending upon the areas of the sheet member.

The first nonconductive sheet (B) and the second nonconductive sheet (D) may be the same or different.

The step of obtaining the ZD sheet laminate (E) by alternately stacking said zebra-like sheet and said nonconductive sheet (D) is the same as that of obtaining the AB sheet laminate (C) from the above-described conductive sheet (A) and the nonconductive sheet (B). Further, the second step of cutting said ZD sheet laminate (E) in a predetermined thickness is the same as the first step of cutting the above-described AB sheet laminate (C).

### BRIEF DESCRIPTION OF THE DRAWINGS

FIG. 1 is a plan view illustrating an anisotropic conductive sheet according to an embodiment of the present invention.

FIG. 2 is a plan view of the upper left portion of the anisotropic conductive sheet according to the embodiment of the present invention shown in FIG. 1.

FIG. 3 relates to a method for manufacturing the anisotropic conductive sheet according to an embodiment of the present invention, illustrating the step of laminating conductive sheets and nonconductive sheets.

FIG. 4 relates to a method for manufacturing the anisotropic conductive sheet according to an embodiment of the present invention, illustrating the step of cutting a laminate of the conductive sheets and nonconductive sheets laminated in FIG. 3.

FIG. 5 relates to a method for manufacturing the anisotropic conductive sheet according to an embodiment of the present invention, illustrating the step of laminating the sheets cut in FIG. 4 and the nonconductive sheets.

FIG. 6 relates to a method for manufacturing the anisotropic conductive sheet according to an embodiment of the present invention, illustrating the step of cutting the laminate laminated in FIG. 5.

FIG. 7 is a flowchart illustrating the steps of manufacturing the laminate (C) and a zebra-like sheet member in the method for manufacturing the anisotropic conductive sheet according to an embodiment of the present invention.

FIG. 8 is a flowchart illustrating the steps of manufacturing the anisotropic conductive sheet from the zebra-like sheet member and such in the method for manufacturing the anisotropic conductive sheet according to an embodiment of the present invention.

FIG. 9 is a plan view of the anisotropic conductive sheet according to another embodiment of the present invention.

FIG. 10 is a sectional view of the anisotropic conductive sheet according to another embodiment of the present invention across A-A in FIG. 9.

FIG. 11 is a sectional view of the anisotropic conductive sheet according to another embodiment of the present invention across B-B in FIG. 9.

### DESCRIPTION OF THE PREFERRED EMBODIMENT

Hereinafter the present invention will be described in more detail by way of embodiments with reference to the drawings. However, the embodiments are simply to illustrate specific materials and numerical values as preferred examples of the invention, but are not to limit the invention.

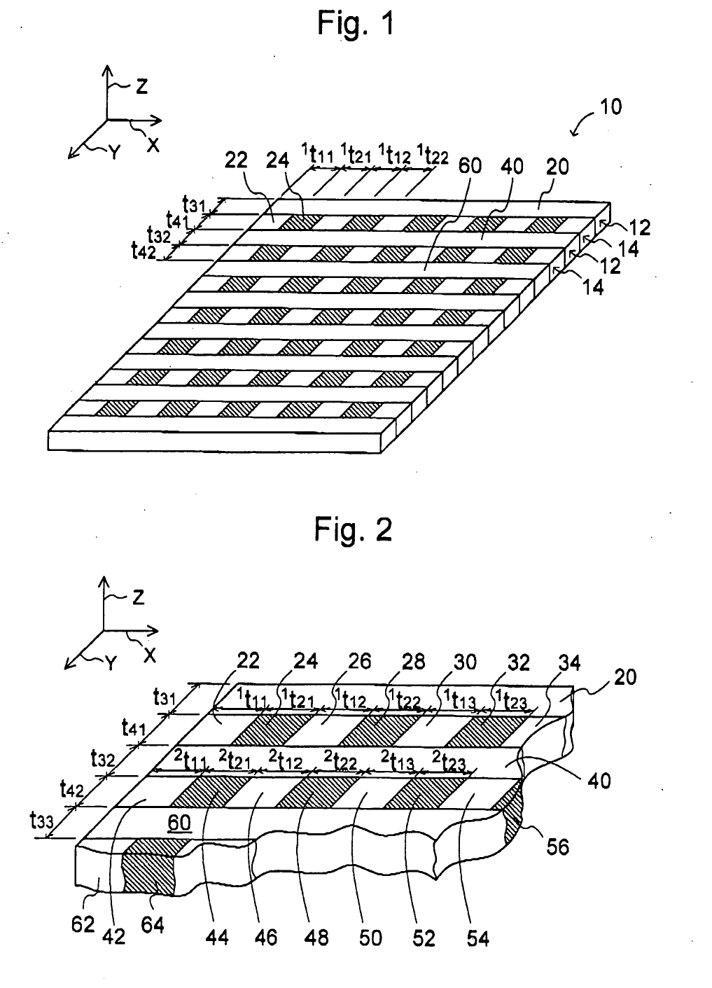

FIG. 1 illustrates an anisotropic conductive sheet 10 according to an embodiment of the present invention. A Cartesian coordinate system XYZ of the anisotropic conductive sheet 10 is illustrated at a left upper part (the same also holds in FIG. 2). The anisotropic conductive sheet 10 of this embodiment is a rectangular sheet member in which there are alternately arranged nonconductive strip-like members 12 and strip-like members 14 of a striped pattern having conductive pieces and nonconductive pieces that are alternately arranged. The neighboring nonconductive strip-like members 12 and strip-like members 14 of the striped pattern are coupled together using a coupling agent. In the anisotropic conductive sheet of this embodiment, a conductive elastomer and a nonconductive elastomer are used for the nonconductive strip-like members 12 and for the strip-like members 14 of the striped pattern. As the conductive elastomer, a conductive silicone rubber manufactured by Shin-etsu Polymer Co. is used. As the nonconductive elastomer, there is used a silicone rubber and such manufactured by Mitsubishi Jushi Co. or a silicone rubber manufactured by Shin-etsu Polymer Co. Further, in the anisotropic conductive sheet of this embodiment, there is used a suitable coupling agent which is a silane coupling agent manufactured by Shin-etsu Polymer Co.

FIG. 2 is a partial enlarged view of the upper left portion of FIG. 1, illustrating the nonconductive strip-like members 12 and the strip-like members 14 of the striped pattern in more detail. The nonconductive strip-like members 12 of FIG. 1 correspond in FIG. 2 to nonconductive strip-like members 20, 40, 60, etc. The strip-like members 14 of the striped pattern of FIG. 1 correspond in FIG. 2 to the strip-like member of the striped pattern comprising nonconductive pieces 22, 26, 30, 34, etc. and conductive pieces 24, 28, 32, etc. and to the strip-like member of the striped pattern comprising nonconductive pieces 42, 46, 50, 54, etc. and conductive pieces 44, 48, 52, 56, etc. Namely, the nonconductive strip-like member 20 is neighbored by a strip-like member of a striped pattern comprising nonconductive pieces 22, 26, 30, 34, etc. and conductive pieces 24, 28, 32, etc., which is further neighbored by a nonconductive strip-like member 40, and is further neighbored by a strip-like member of a striped pattern comprising nonconductive pieces 42, 46, 50, 54, etc. and conductive pieces 44, 48, 52, 56, etc. In this embodiment, the strip-like members have nearly the same thickness (T). The two strip-like members neighboring as described above are coupled together with the coupling agent. The conductive pieces and the nonconductive pieces neighboring to constitute the strip-like members 14 of the striped pattern are also coupled with the coupling agent to constitute a piece of sheet as shown in FIG. 1. Here, the coupling agent is nonconductive, and the sheet maintains the non-conductivity in the direction of a plane.

The nonconductive strip-like members 20, 40, 60 and such have widths t₃₁, t₃₂, t₃₃, . . . , t₃ₖ (k is a natural number of not smaller than 4), and the strip-like members 14 of the striped pattern have widths 4₄₁, t₄₂, t₄₃, . . . , t₄ₖ (k is a natural number of not smaller than 4). In this embodiment, these widths are all the same. In other embodiments, however, the widths may be all the same or may be all different. These widths can be easily adjusted in the method for producing the anisotropic conductive sheet of this embodiment that will be described later. Further, the strip-like members 14 of the striped pattern are constituted by nonconductive pieces 22, 26, 30, 34, . . . ; 42, 46, 50, 54, . . . having lengths ¹t₁₁, ¹t₁₂, ¹t₁₃, . . . ¹t₁ₘ (m is a natural number of not smaller than 4); ²t₁₁, ²t₁₂, ²t₁₃, . . . ²t₁ₙ (n is a natural number of not smaller than 4), and conductive pieces 24, 28, 32, . . . ; 44, 48, 52, . . . having lengths ¹t₂₁, ¹t₂₂, ¹t₂₃, . . . , ¹t₂ₘ (m is a natural number of not smaller than 4); ²t₂₁, ²t₂₂, ²t₂₃, . . . , ²t₂ₙ (n is a natural number of not smaller than 4). In this embodiment, the lengths of these members are all the same. In other embodiments, however, the lengths may all be the same or may be all different. These lengths can be easily adjusted in the method of producing the anisotropic conductive sheet of the embodiment that will be described later.

In this embodiment, the conductive pieces in the strip-like members of the striped pattern have a length of approximately 50 μm, the nonconductive pieces have a length of approximately 30 μm, the strip-like members of the striped pattern have a width of approximately 50 μm and the nonconductive strip-like members have a width of approximately 50 μm. Needless to say, in other embodiments, the lengths may be longer (or larger) or shorter (or smaller), as a matter of course.

In the case of this embodiment, the recurring distance corresponds to a value obtained by adding up the lengths of the two neighboring elastomers of different kinds and dividing the sum by 2, that is, [(^{k}t₁ₘ+^{k}t₂ₘ)/2] or [(^{k}t₁ₘ+^{k}t₂₍ₘ₋₁₎)/2]. As for the whole anisotropic conductive sheet, a mean value of these values may be used, a minimum value may be used, or a minimum value or an average value of a required place of the sheet may be used. When the mean value is used, the sheet as a whole exhibits fine pitch performance. When the minimum value is used, a minimum gap between the terminals that can be guaranteed is defined. When the conductive elastomer is arranged relatively uniformly, further, the frequency of appearance of the conductive elastomer of a predetermined length may be used per a unit length or the cumulative length of the conductive elastomers may be used in the strip-like members of the striped pattern. In this embodiment, the recurring distance is approximately 40 μm even if a mean value or a minimum value is used, and the cumulative length of the conductive elastomers per a unit length is approximately 0.6 mm/mm.

The size of the anisotropic conductive sheet of this embodiment can be clearly indicated by adding up the widths and lengths described above. However, there is no limitation on the width or on the length, and there is no limitation, either, on the thickness T (the anisotropic conductive sheet of this embodiment has a thickness of approximately 1 mm). When used for connecting the circuit board to the terminals of the electronic parts, however, it is desired that the size matches with these sizes. In this case, the sizes are, usually, 0.5˜3.0 cm×0.5˜3.0 cm and 0.5˜2.0 mm in thickness.

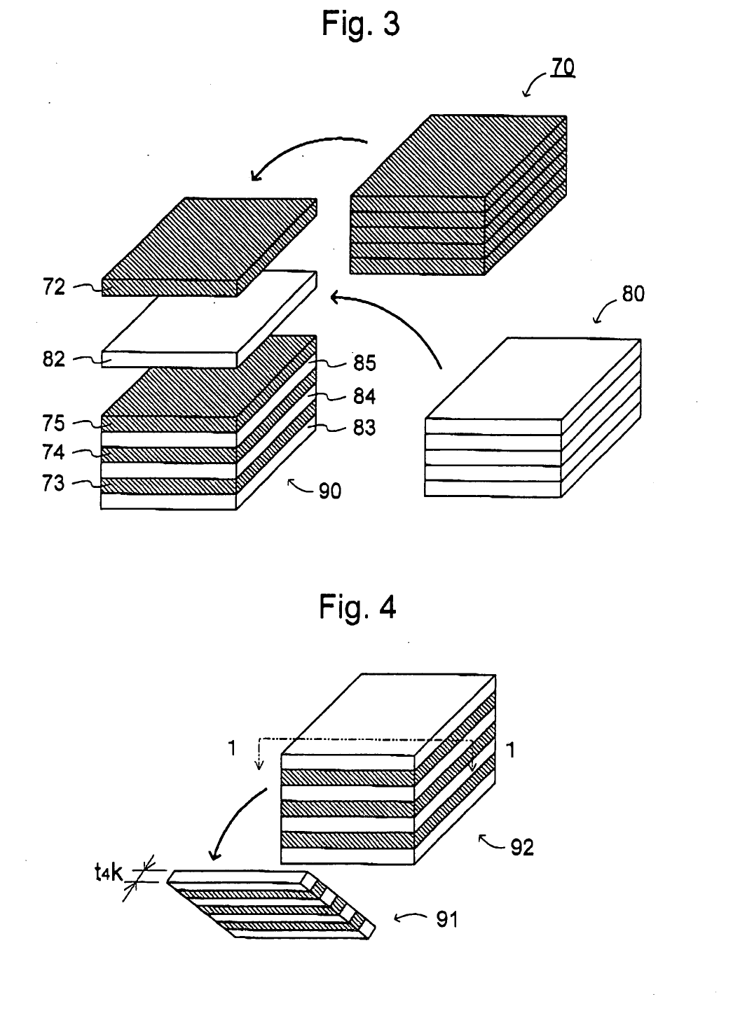

A method of manufacturing the anisotropic conductive sheet of the above embodiment will be described with reference to FIGS. 3 to 6. Referring to FIG. 3, there are provided conductive sheets (A) 70 and nonconductive sheets (B) 80, from which the sheet members are alternately stacked to prepare an AB sheet laminate (C). On the AB sheet laminate (C) 90 being stacked, there are further stacked the nonconductive sheet (B) 82 and the conductive sheet (A) 72 further thereon. A coupling agent is applied among these sheet members so that the sheet members are coupled together. The nonconductive sheet (B) 83 is arranged at the lowest part of the AB sheet laminate (C) 90 which is being stacked. It should be noted that the thickness of this sheet member corresponds to ¹t₁₁ in FIGS. 1 and 2, the thickness of the conductive sheet (A) 73 just thereon corresponds to ¹t₂₁ in FIGS. 1 and 2, and the thicknesses of the sheet members 84, 74, 85, 75 correspond, respectively to ¹t₁₂, ¹t₂₂, ¹t₁₃, ¹t₂₃ in FIGS. 1 and 2. That is, lengths of the nonconductive pieces and the conductive pieces in the strip-like member 14 of the striped pattern in FIGS. 1 and 2 can be freely varied by varying the thickness of these sheet members. Similarly, lengths ²t₁₁, ²t₂₁, ²t₁₂, ²t₂₂, ²t₁₃, ²t₂₃ of the members of the strip-like member of the striped pattern sandwiched between the nonconductive strip-like members 40 and 60 correspond to the thicknesses of the corresponding nonconductive and conductive sheets. Usually, these thicknesses are not larger than approximately 80 μm, and, as fine pitches, are, more, preferably, not larger than approximately 50 μm. In this embodiment, the thicknesses are so adjusted that the nonconductive pieces have a length of approximately 30 μm and the conductive pieces have a length of approximately 50 μm.

To alternately stack the conductive sheets and nonconductive sheets, the conductive sheets may be continuously stacked in two or more pieces and, then, the nonconductive sheets may be stacked in one or more pieces. The invention may further include continuously stacking two or more pieces of nonconductive sheets and, then, stacking one or more pieces of conductive sheets alternately.

FIG. 4 illustrates a first step of cutting the AB sheet laminate (C) 92 prepared by the step of obtaining the AB sheet laminate. The AB sheet laminate (C) 92 is cut along a cutting line 1-1 such that the thickness of the obtained sheet 91 of the zebra-like pattern becomes a desired thickness t₄ₖ (k is a natural number). This thickness t₄ₖ corresponds to t₄₁, t₄₂ and so on in FIGS. 1 and 2. Thus, the widths of the strip-like members 14 of the striped pattern in FIGS. 1 and 2 can be freely adjusted, and may be all the same or different. Usually, the widths are not larger than approximately 80 μm and, more desirably, not larger than approximately 50 μm. In this embodiment, the widths are approximately 50 μm.

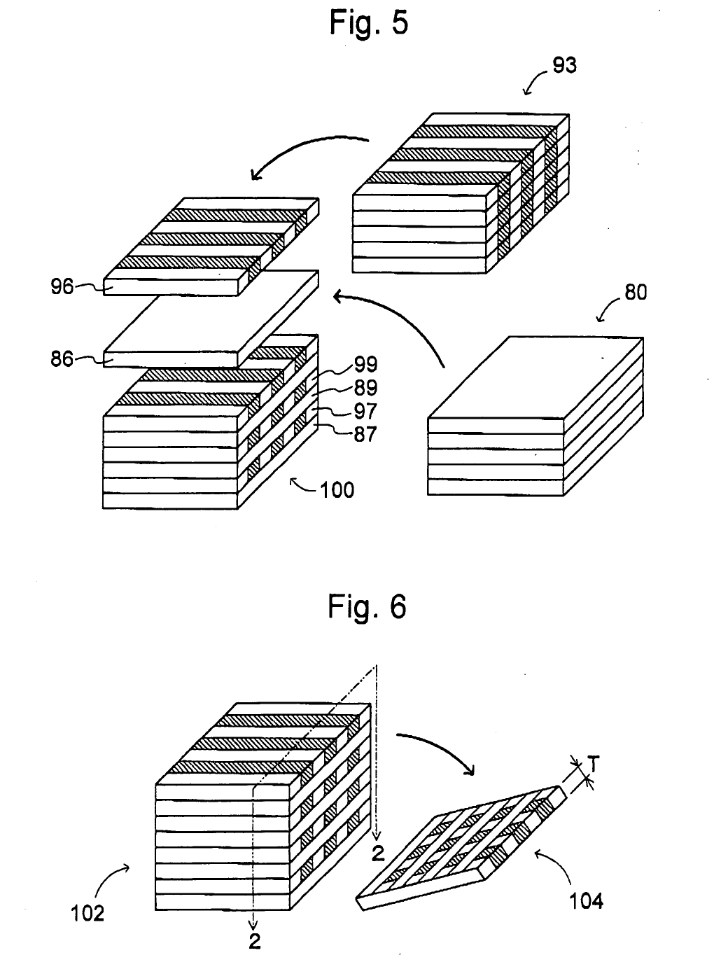

FIG. 5 illustrates the preparation of the ZD sheet laminate (E) by alternately laminating the zebra-like sheet 93 prepared in the first step of cutting and the nonconductive sheet (D) 80. On the ZD sheet laminate (E) 100 being stacked, there are further stacked the nonconductive sheet 86 and the zebra-like sheet 96 thereon. A coupling agent is applied among these sheet members so that the sheet members are coupled together. The nonconductive sheet 87 is arranged at the lowest part of the ZD sheet laminate 100 that is being stacked. It should be noted that the thickness of this sheet member corresponds to t₃₁ which is the width of the nonconductive strip-like member 12 in FIGS. 1 and 2, the thickness of the sheet member 97 just thereon corresponds to t₄₁ in FIGS. 1 and 2, and the thicknesses of the sheet members 89 and 99 correspond to t₃₂ and t₄₂ in FIGS. 1 and 2, respectively. That is, widths of the nonconductive strip-like members 12 and of the strip-like members 14 of the striped pattern in FIG. 1 can be freely varied by varying the thickness of these sheet members. Usually, these widths are not larger than approximately 80 μm, and, are, as fine pitches, more preferably, not larger than approximately 50 μm. In this embodiment, the thicknesses are so adjusted that the nonconductive strip-like members 12 have a width of approximately 30 μm and the strip-like members 14 of the striped pattern have a width of approximately 50 μm.

FIG. 6 illustrates the second step of cutting the ZD sheet laminate (E) 102 prepared through the step of obtaining the ZD sheet laminate. The laminate 102 is cut along a cutting line 2-2 such that the obtained anisotropic conductive sheet 104 will have a desired thickness T. Therefore, this makes it easy to prepare a thin anisotropic conductive sheet and a thick anisotropic conductive sheet that are usually difficult to obtain. Though the thickness is usually approximately 1 mm, it can be decreased to be not larger than approximately 100 μm (or not larger than approximately 50 μm when particularly desired) or can be increased to be about several millimeters. In this embodiment, the thickness is selected to be approximately 1 mm.

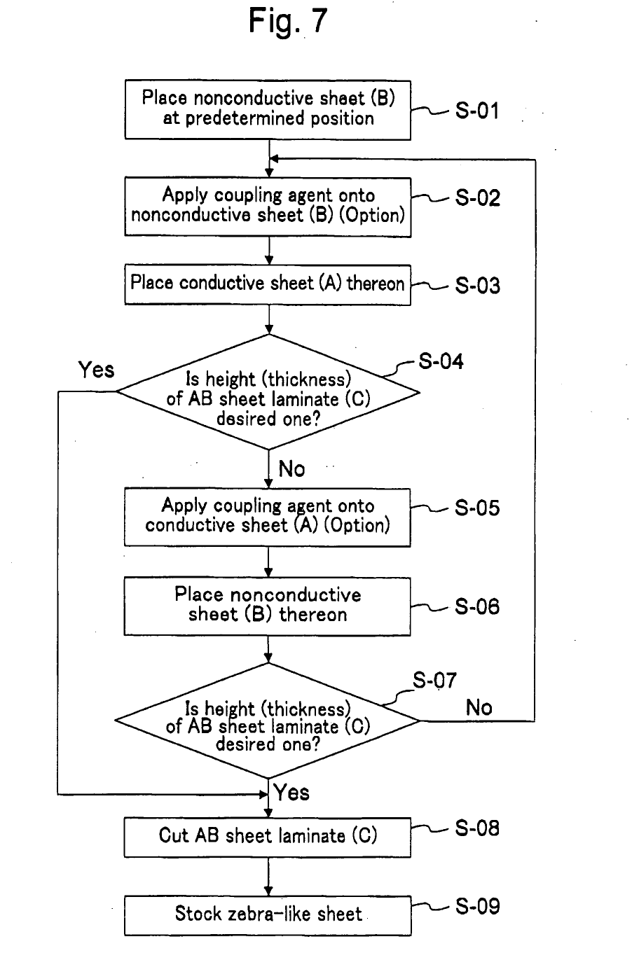

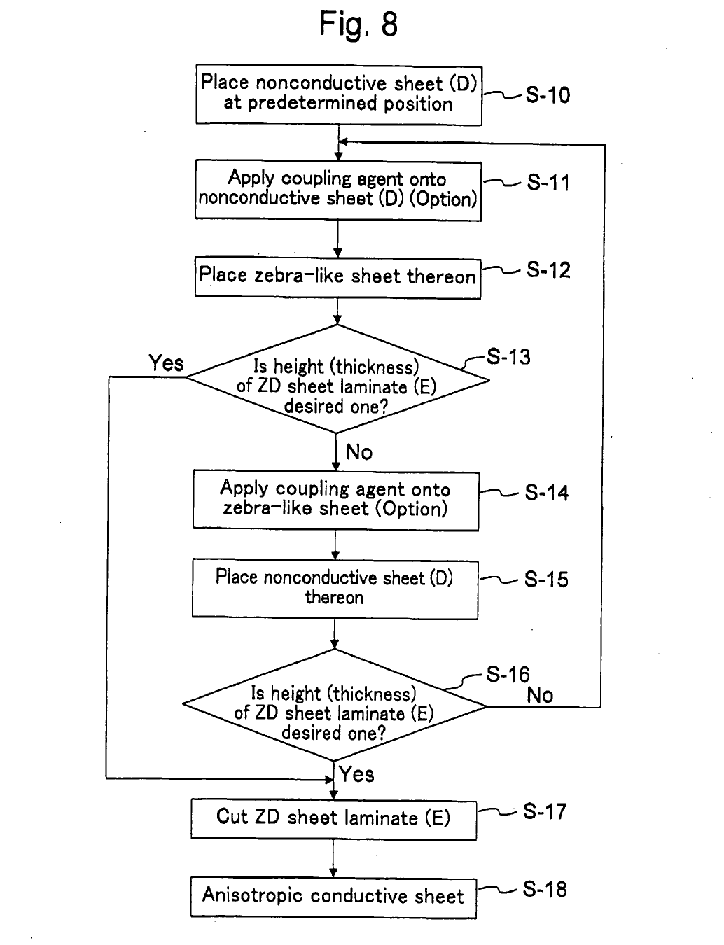

FIGS. 7 and 8 are flowcharts describing a method of manufacturing the above-described anisotropic conductive sheet. FIG. 7 describes the steps of preparing the zebra-like sheet. First, the nonconductive sheet (B) is placed at a predetermined position for stacking (S-01). Optionally, the coupling agent is applied onto the nonconductive sheet (B) (S-02). This step may be omitted, as a matter of course, since it is optional (the same holds hereinafter). The conductive sheet (A) is placed thereon (S-03). Check if the thickness (or height) of the stacked AB sheet laminate (C) is reaching a desired thickness (or height) (S-04). If the desired (predetermined) thickness has been reached, the routine proceeds to the first step of cutting (S-08). If the desired (predetermined) thickness has not been reached, the coupling agent is optionally applied onto the conductive sheet (A) (S-05). The nonconductive sheet (B) is placed thereon (S-06). Check if the thickness (or height) of the stacked AB sheet laminate (C) is reaching a desired thickness (or height)(S-07). If the desired thickness has been reached, the routine proceeds to the first step of cutting (S-08). If the desired thickness has not been reached, the routine returns back to step S-02 where the coupling agent is optionally applied onto the nonconductive sheet (B). At the first step of cutting (S-08), the zebra-like sheet is cut out piece by piece or in a plurality of pieces at one time, and the zebra-like sheets are stocked (S-09).

FIG. 8 describes steps of obtaining the ZD sheet laminate for preparing an anisotropic conductive sheet from the zebra-like sheet and the nonconductive sheet (D). First, the nonconductive sheet (D) is placed on a predetermined position for stacking (S-10). Optionally, the coupling agent is applied onto the nonconductive sheet (D) (S-11). The zebra-like sheet is placed thereon (S-12). Check if the thickness (or height) of the stacked ZD sheet laminate (E) is reaching a desired thickness (or height) (S-13). If the desired thickness has been reached, the routine proceeds to the second step of cutting (S-17). If the desired thickness has not been reached, the coupling agent is optionally applied onto the zebra-like sheet (S-14). The nonconductive sheet (D) is placed thereon (S-15). Check if the thickness (or height) of the ZD sheet laminate (E) is reaching a desired thickness (or height) (S-16). If the desired thickness has been reached, the routine proceeds to the second step of cutting (S-17). If the desired thickness has not been reached, the routine returns back to step S-11 where the coupling agent is optionally applied onto the zebra-like sheet. At the second step of cutting (S-17), the anisotropic sheet is cut out piece by piece or in a plurality of pieces at one time (S-18).

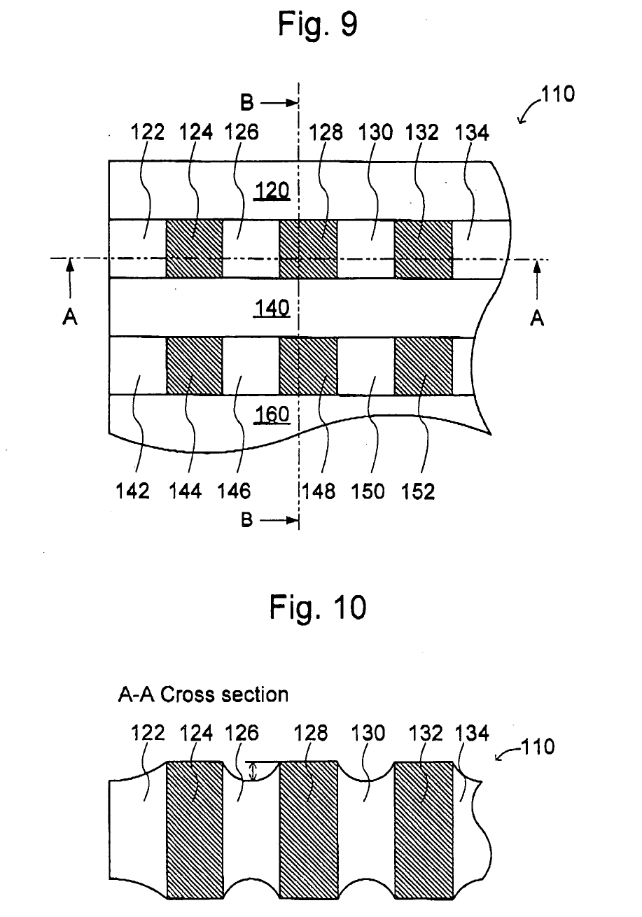

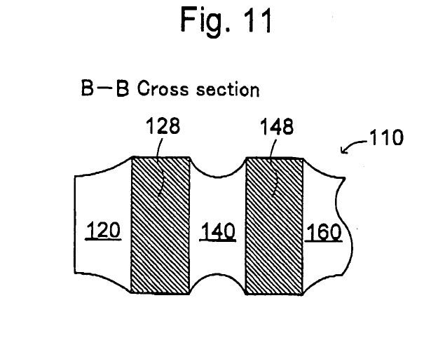

FIGS. 9, 10 and 11 illustrate a second embodiment. In this second embodiment, an anisotropic conductive sheet 110 was prepared according to the method as described above by using conductive sheets that have been cured and nonconductive sheets that have not been cured. FIGS. 10 and 11 are sectional views of the anisotropic conductive sheet 10 along the lines A-A and B-B. As will be understood from these drawings, the conductive pieces 124, 128, 132 and 148 are protruded on the surface of the sheet to be higher than the nonconductive pieces 122, 126, 130, 134, 120, 140 and 160 offering improved reliability of contact. This form is assumed since uncured rubber has contracted due to the heating. Here, the conductive elastomer has been cured and the nonconductive elastomer has not been cured. The uncured nonconductive elastomer can be adhered to the cured elastomer by heating or the like. In the above manufacturing method, therefore, the optional coupling agent needs not necessarily be added and may be omitted from the steps.

As described above, the anisotropic conductive sheet of the invention has the effect of not only maintaining insulation in the direction of the plane while exhibiting satisfactory conductivity in the direction of thickness but also enabling the sizes such as lengths of the nonconductive pieces and conductive pieces to be freely set so as to easily accomplish fine pitches desired for achieving a high degree of integration. Further, since the conductive pieces and nonconductive pieces are chemically bonded together (cross-linking of rubber), the conductive portions do not slip out as likely, otherwise, to tend to occur when a linear metal is used as conductive portions. Besides, the conductive pieces are surely surrounded by the nonconductive pieces avoiding contact caused by the approach/contact of conductive particles of a metal or the like in the direction of plane of the anisotropic conductive sheet in which conductive particles are mixed. The anisotropic conductive sheet according to the invention uses the strip-like members of the striped pattern and the nonconductive strip-like members as constituent elements. By adjusting the coupled state among the strip-like members, therefore, it is expected that the cutting is facilitated in the direction of the strip-like members.

1. An anisotropic conductive sheet expanding on a plane, wherein when a direction included in said plane is denoted as X-direction, a direction orthogonal to X-direction and contained in said plane is denoted as Y-direction, and a direction orthogonal to both X-direction and Y-direction is denoted as Z-direction, the anisotropic conductive sheet comprising: a predetermined thickness in Z-direction; a front surface and a back surface substantially in parallel with said plane (X-Y plane); strip-like members having a width in Y-direction and extending in X-direction and having a striped pattern with conductive pieces and nonconductive pieces alternately arranged along X-direction, and nonconductive strip-like members having a width in Y-direction and extending in X-direction, wherein the strip-like members and the nonconductive strip-like members are arranged alternately in Y-direction.

2. The anisotropic conductive sheet according to claim 1, wherein recurring distance of a conductive piece and a nonconductive piece in the strip-like member of the striped pattern is not longer than approximately 80 μm in X-direction and is not longer than approximately 110 μm in Y-direction, each strip-like member of the striped pattern has a width of not longer than approximately 80 μm, and each nonconductive strip-like member has a width of not longer than approximately 80 μm.

3. The anisotropic conductive sheet according to claim 1, wherein the conductive pieces are composed of conductive elastomer; wherein the nonconductive pieces are composed of first nonconductive elastomer; and wherein the nonconductive strip-like members are composed of second nonconductive elastomer.

4. The anisotropic conductive sheet according to claim 3, wherein the conductive pieces, the nonconductive pieces and/or the strip-like members of the striped pattern, and the nonconductive strip-like members are chemically bonded, and wherein such chemical bonding is at least partly accomplished by utilizing a coupling agent.

5. The anisotropic conductive sheet according to any one of claim 1, wherein on the front surface and/or on the back surface of the anisotropic conductive sheet, the conductive pieces are protruding beyond the surrounding nonconductive pieces or the nonconductive strip-like members.

6. The anisotropic conductive sheet according to claim 1, wherein the strip-like members of the striped pattern have a rectangular parallelopiped shape.

7. The anisotropic conductive sheet according to claim 1, wherein the nonconductive strip-like members have a rectangular parallelopiped shape.

8. A method of manufacturing a flexible anisotropic conductive sheet having a predetermined thickness, and predetermined front surface and back surface on the front and back across the thickness, the method comprising:
a step of alternately laminating a conductive sheet (A) and a first nonconductive sheet (B) to obtain an AB sheet laminate (C);
a first step of cutting the AB sheet laminate (C) obtained in the step of obtaining the AB sheet of a predetermined thickness to obtain a zebra-like sheet;
a step of alternately laminating the zebra-like sheet obtained in the first cutting step and a second nonconductive sheet (D) to obtain a ZD sheet laminate (E); and
a second step of cutting the ZD sheet laminate (E) obtained in the step of obtaining the ZD sheet laminate of a predetermined thickness.

9. A method of manufacturing the anisotropic conductive sheet, wherein: in the step of obtaining the AB sheet laminate, a coupling agent is applied to the nonconductive sheet (B) prior to laminating the conductive sheet (A) on the nonconductive sheet (B) and the coupling agent is applied to the conductive sheet (A) prior to laminating the nonconductive sheet (B) on the conductive sheet (A), and wherein: in the step of obtaining the ZD sheet laminate, the coupling agent is applied to the nonconductive sheet (D) prior to laminating the zebra-like sheet on the nonconductive sheet (D), and the coupling agent is applied to the zebra-like sheet prior to laminating the nonconductive sheet (D) on the zebra-like sheet.
